(19) United States
(12) Patent Application Publication
(10) Pub. No.: US 2007/0061177 A1
(43) Pub. Date: Mar. 15, 2007

(54) Method for providing a contextual view of a process step

(75) Inventors: Gil Thieberger, Kiryat Tivon (IL); Michal Rosenfeld, Haifa (IL); Michael Karasik, Jerusalem (IL)

Correspondence Address: Active Knowledge Ltd., POB 294, Kiryat Tivon, 36010, IL

(73) Assignee: Active Knowledge Ltd., Kiryat Tivon (IL)

(21) Appl. No.: 11/520,015

(22) Filed: Sep. 13, 2006

Related U.S. Application Data
(60) Provisional application No. 60/716,490, filed on Sep. 14, 2005.

(51) Int. Cl. G06F 9/44

(52) U.S. Cl. 705/7

(57) ABSTRACT

A computer implemented method for providing a contextual view of a specified process step, including the steps of receiving an indication of relevancy of at least one element of the specified process step to a current process step, wherein the current process step is not the specified process step, and providing a user with the contextual view of the specified process step, wherein the contextual view of the specified process step includes relevant elements based on the received indication of relevancy.

### CROSS-REFERENCE TO RELATED APPLICATIONS

This application claims the benefit of U.S. Provisional Patent Application Ser. No. 60/716,490, filed on Sep. 14, 2005, which is incorporated herein by reference.

### FIELD OF THE INVENTION

The embodiments of the present invention relate to software and, more particularly, to methods for providing a contextual view of a specified process step based on the current process step.

### BACKGROUND

Workflow, business process, and electronic data entry based systems allow an enterprise to formalize the processes by which the enterprise achieves its business objectives. Such systems provide step-by-step descriptions of tasks which should be performed as part of the work, so that individuals or groups within the enterprise can be assigned individual (or groups of) tasks. The tasks may be dependent or independent upon one another.

### BRIEF SUMMARY

The embodiments of the present invention relate to software and, more particularly, to methods for providing a contextual view of a specified process step based on the current process step.

Implementation of the embodiments of the present invention involves performing or completing selected tasks or steps manually, semi-automatically, fully automatically, and/or a combination thereof Moreover, depending upon actual instrumentation and/or equipment used for implementing an embodiment of the disclosed methods, several embodiments could be achieved by hardware, by software, by firmware, or a combination thereof.

### BRIEF DESCRIPTION OF THE DRAWINGS

The embodiments of the present invention are herein described, by way of example only, with reference to the accompanying drawings. With specific reference now to the drawings, it is stressed that the particulars shown are by way of example and for purposes of illustrative discussion of the embodiments of the present invention only, and are presented in order to provide what is believed to be the most useful and readily understood description of the principles and conceptual aspects of the embodiments of the present invention. In this regard, no attempt is made to show structural details of the embodiments in more detail than is necessary for a fundamental understanding of the invention. The description taken with the drawings makes apparent to those skilled in the art how the several embodiments may be embodied in practice. Identical structures, elements or parts which appear in more than one figure are preferably labeled with a same or similar number in all the figures in which they appear. In the drawings:

FIG. 1 is a flow diagram of a general embodiment in accordance with the present invention;

FIG. 2 is a more detailed flow diagram of an embodiment in accordance with the present invention;

FIGS. 3A-B are schematic illustrations of an embodiment for providing different data based on the current process step, in accordance with the present invention;

FIGS. 4A-B are schematic illustrations of an embodiment for providing different data based on the current process step and the role, in accordance with the present invention;

FIGS. 5A-B are additional schematic illustrations of providing different data based on the current process step and the role, in accordance with the present invention;

FIGS. 6A-B are schematic illustrations of an embodiment of abstraction, in accordance with the present invention;

FIGS. 7A-B are schematic illustrations of another embodiment for providing different process step views, in accordance with the present invention;

FIGS. 8A-B are flow diagrams of embodiments in accordance with the present invention;

FIG. 9 is a schematic illustration of an exemplary hierarchical tag, in accordance with the present invention; and

FIG. 10 is a schematic illustration of an exemplary hierarchical tag, in accordance with an embodiment of the present invention.

### DETAILED DESCRIPTION

In the following description, numerous specific details are provided to provide a thorough understanding of embodiments of the invention. One skilled in the relevant art, however, will recognize that the embodiments may be practiced without one or more of these specific details, or with other equivalent elements and components, etc. In other instances, well-known components and elements are not shown, or not described in detail, to avoid obscuring aspects of the invention or for brevity.

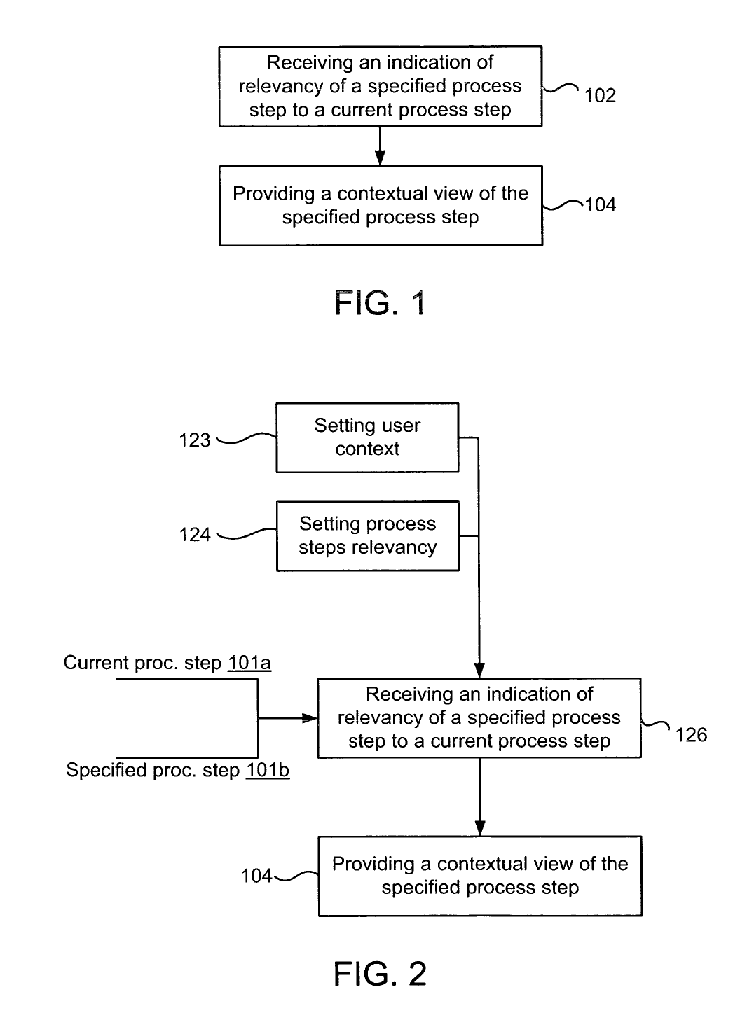

The following disclosure provides a brief, general description of a suitable computing environment in which the embodiments of the present invention may be implemented. Those skilled in the relevant art will appreciate that the embodiments may be practiced with other computer system configurations, including hand-held devices, multiprocessor systems, microprocessor-based or programmable consumer electronics, network PCs, network computers, mini computers, mainframe computers, and the like. The embodiments may be practiced in distributed computing environments where tasks or modules are performed by remote processing devices, which are linked through a communications network. In a distributed computing environment, program modules may be located in both local and remote memory storage devices. The embodiments may be practiced in hardware, programmable devices, and other equivalents. Referring to the figures, as illustrated in FIG. 1, in an embodiment of the present invention, a method for providing a contextual view of a specified process step comprises the steps of: receiving an indication of relevancy of at least one element of the specified process step to a current process step 102, wherein the current process step is not the specified process step, and providing a user with the contextual view of the specified process step 104, wherein the contextual view of the specified process step comprises relevant elements based on the received indication of relevancy.

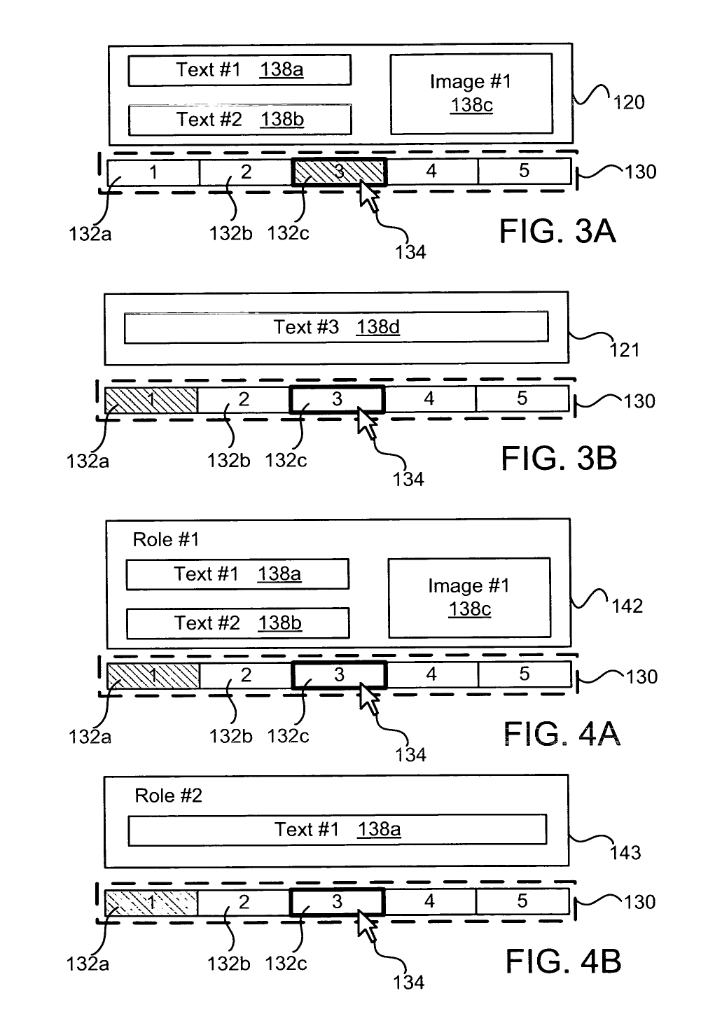

Referring to FIG. 3A and FIG. 3B, an embodiment of the present invention features content areas 120 and 121 respectively, comprising elements 138a-138d, a process toolbar 130, process steps 132a-132c, and a pointer 134. FIG. 3A illustrates the case where process step 132c is both the current process step and the specified process step, whereby the specified process step is illustrated by a pointer 134. FIG. 3B illustrates the case where process step 132a is the current process step and is different from the specified process step which is process step 132c (whereby the specified process step is indicated by the pointer 134). The content area 121, as illustrated in FIG. 3B is different from the content area 120, as illustrated in FIG. 3A. Elements 138a-138d, are only an exemplary content that is used for illustrative purposes only and are not intended to limit the scope of the present invention. The specified process step indicated by the pointer 134 refers to the process step that is provided to the user. The process step may be provided to the user by visual means, audio means or any other appropriate means. The user may select the specified process step by using any means, such as a mouse, voice command, and/or a keyboard. The indication of relevancy may be set in advance or calculated on demand. For example, the indication of relevancy may be set by the user entering the data. Alternatively, the indication of relevancy may be set automatically by the system wherein the indication of relevancy is calculated using Business Data such as business process parameters, or using data from the user's profile.

In an embodiment of the invention, the indication of relevancy is received by using one or more of the following methods, or an equivalent thereof:

1) The relevancy of each element is determined by a set of rules operated on the process step and/or on one or more elements within the process step. US patent application No. 20060107197, entitled “Role-dependent action for an electronic form”, which is incorporated herein by reference, is an example of the relevancy by role approach.

2) Implementing the process elements as business objects associated with operations, wherein the operations may be prioritized. US patent application No. 20050288945, entitled “Object based navigation”, which is incorporated herein by reference, is an example of associating operations with business objects.

3) The indication of relevancy may be received by using a web service, wherein the web service stores the indication of relevancy for at least one element and/or for the entire process step. The web service may be a Service Oriented Architecture (SOA) or Enterprise Service Oriented Architecture (ESOA).

4) The data that is indicating the relevancy may be stored as content fragments, where the fragments are pieces of reusable content and/or metadata that can be used in multiple documents, pages, or any artifacts that are managed by the system. US patent application No. 20050149862, entitled “System and method for context sensitive content management”, which is incorporated herein by reference, is an example of the content fragments approach.

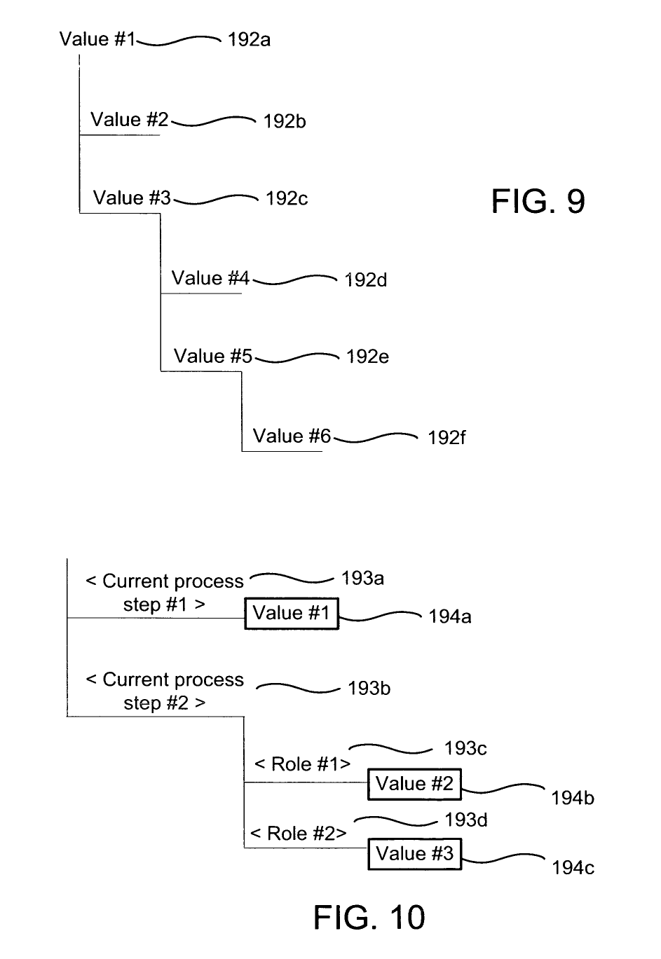

5) Storing the indication of relevancy of each element and/or a process step in a tag. The tag is a data structure that makes it possible to adapt the content to different scenarios by using the tag's data. The tag's data may be stored hierarchically, for example to correspond with multiple values of a user's context. Optionally, the tag may be implemented as a function, which may be used by scripts or other programmable tools. An element may have no tags, one tag, or more than one tag. The tags may be embedded or not embedded in the clement. FIG. 9 illustrates a hierarchical tag. Values #1-#6, referred to as 192a-192f, may be a number, string, script or any other means used for calculating the value of the tag. Because of the hierarchical structure, a specific value of a tag may be interpreted based on other values in the tag tree. For example, according to the chosen tag interpretation, value #5 192e may be interpreted as a concatenation of value #1 192a and value #3 192c and value #5 192e; alternatively, value #5 192e may be interpreted as a concatenation of only some of the hierarchical values, for example, that of value #3 192c and value #5 192e; alternatively, value #5 192e may be interpreted as a weighted sum, such as alfa1*value #1 192a+alfa2*value #3 192c+alfa3*value #5 192e. It is to be understood that the various values may themselves be tags, and/or be combined with other values to produce a tag.

Hierarchic tags may be better understood if treated similarly to an access-rights tree, wherein a user has to meet all the conditions along a branch in order to have access to a leaf node. FIG. 10 illustrates an exemplary tree of a hierarchical tag consistent with an embodiment of the invention. The tree represents a hierarchical tag which provides an indication of relevancy of an element to the user's context. It is noteworthy that a node may have its own value, in addition to having child nodes. Furthermore, a tag may have only nodes and no values at all, wherein the indication of relevancy is a boolean value represented by the existence of nodes. As illustrated, the nodes of the exemplary tag are current process step #1 193a, and current process step #2 193b, which has two child nodes: role #1 193c and role #2 193d. Furthermore, the tag has three values 194a-194c. According to the exemplary tag, for a user whose context is <current process step #2> and <role #2>, the relevancy of an element associated with the hierarchical tag is indicated by value #3. For example, value #3 may indicate a specific manner in which the element is to be presented to the user.

In an embodiment of the invention, all the different tags in the system have the same structure. As a result, the same weighting, same tag matching mechanism, same context analysis, same properties analysis and/or same management may be used for all elements featuring tags. Using the same structure for all or most of the tags in the system makes it possible to easily analyze the context and deduce the relevancy. Moreover, the same tag handling mechanism may be used in order to reduce computation time, increase compatibility and agility, reduce software development time, and increase the data integrity of the result as there are less transformations and deductions.

In an embodiment of the invention, the tags are built as an array. In an alternative embodiment, the tags are built hierarchically. Hierarchic tags may enable the system to associate or relate the different tags to each other (using tags as values in the hierarchy) and by that help understand the context. Referring again to FIG. 9, in an exemplary embodiment wherein some of the values represent tags, value #3 192c, representing a first tag, depends on value #1 192a, representing a second tag. Therefore, it is presumed that the logical connection between the first tag and the second tag has a stronger basis than a connection between the first tag and another tag that is not connected to the hierarchical tree illustrated in FIG. 9.

A hierarchic tag branch may be weighted. According to the weight of the branch, the weights of specific elements in the branch may be changed. For example, if an item has a high weight and its branch has a low weight, the weight of the item may be reduced and vice versa. When changing the weight of an element, the branch weight can indicate if the change is reasonable. In an embodiment, the depth of an item in a branch may indicate the significance of the item. As the item is closer to the root, it may be more significant, and optionally its weight should be taken more seriously.

There are cases wherein an element does not have an indication of relevancy. In that case, the relevancy decision usually depends on the context of the problem to be solved and/or on the characteristics of the process to be performed, and does not affect the scope of the present invention. For example, it is possible to decide that an element without an indication of relevancy is relevant to the user, or alternatively, decide that an element without an indication of relevancy is not relevant to the user.

Optionally, an indication of the user context is received, and the step of providing the user with the contextual view of the specified process step is further based on the received indication of the user context. As illustrated by FIG. 2, the method receives the current process step 101a and the specified process step 101b. In addition, the method receives the indication of relevancy, accesses the indication of relevancy, and/or calculates in step 126 the indication of relevancy of the specific process step to the current process step. In order to determine the relevancy, optional steps of setting the user context 123 and setting the relevancy 124 between the current process steps and the specified process steps, are performed. Optionally, steps 123 and 124 are executed in advance.

An indication of the user context may be provided to the algorithm that determines the contextual view of the specified process step in relation to the current process step. In that case, the contextual view of the specified process step provided to the user is comprised of elements that are relevant to the current process step and to the user's context. For example, a process step element may be relevant to a current process step, but when considering the user context it may turn out that the process step element is not relevant to the specific user and therefore should not be provided to the user in spite of the current step being what it is.

The user context may be selected from a large variety of context types. A detailed discussion about exemplary possible contexts is disclosed below.

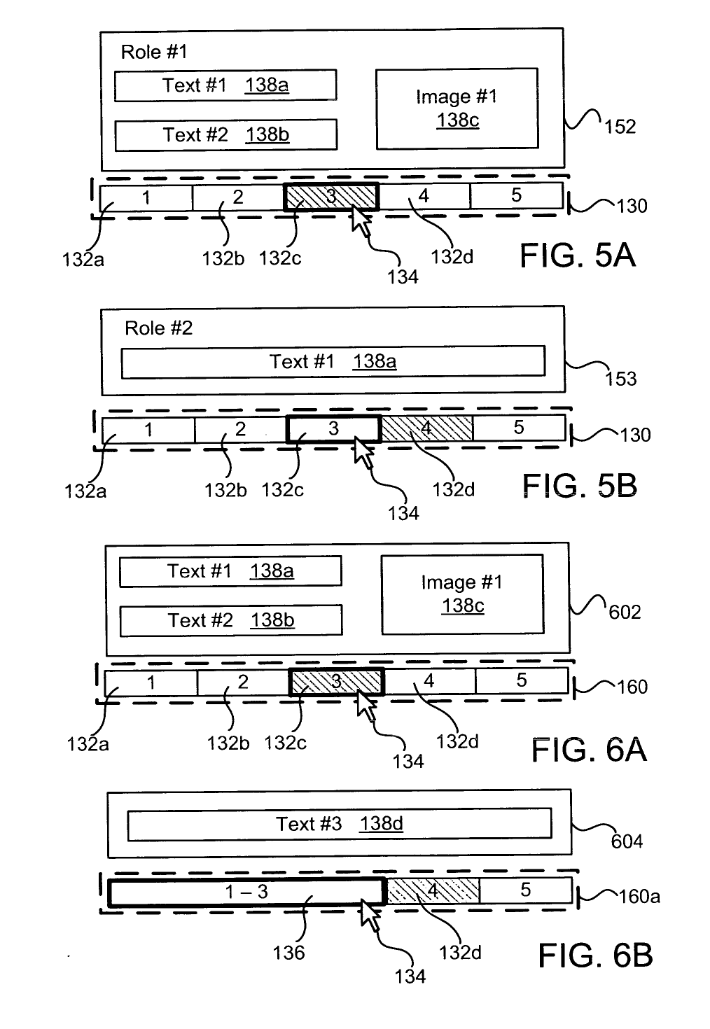

For example, when the user context is a user role, different roles viewing the same process step may be supplied with different content. FIG. 4A and FIG. 4B illustrate the case where both role #1 and role #2 are viewing the same step 132c, but role #1 is supplied with a first content 142, while role #2 is supplied with a second content 143. FIG. 5A and FIG. 5B illustrate the case where the context of the process elements is set according to the current step and the roles. FIG. 5A illustrates the case where process step 132c is the current process step, while FIG. 5B illustrates the case where process step 132d is the current process step. As illustrated in FIG. 5A and FIG. 5B, role #1 and role#2 are viewing the same step 132c, but role #1 is supplied with a first content 152, while role #2 is supplied with a second content 153.

In an option of the method, the received indication of relevancy of at least one element of the specified process step is an indication of relevancy to an element within the current process step. This option enables the system to further focus the user on information relevant to the task at hand. For example, the system may provide in the specified process step more details relevant to the element the user is working on compared with the details provided about the other elements.

In an optional embodiment of the invention, the system receives the current process step and the specified process step. Optionally, the current process step is set by a user as illustrated by 101a and 101b in FIG. 2. For example, when a business analyst wants to simulate the usage of the process, it is possible to simulate a current process step by an arbitrary selection. The current process step may be selected from any kind of process steps list.

In an embodiment of the invention, the specified process step is an abstract view of at least two process steps. Referring to FIG. 6A and FIG. 6B, an embodiment of the present invention features content areas 602 and 604 respectively, comprising elements 138a-138d, a process toolbar 160 and 160a respectively, process steps 132a-132d and 136, and a pointer 134. FIG. 6A illustrates the case where the current process step 132c is the same as the specified process step, whereby the specified process step is illustrated by the pointer 134. FIG. 6B illustrates the case where the current process step 132d is different from the specified process step 136, which is an abstraction of steps 1-3, referenced by 132a-132c in FIG. 6A, whereby the specified process step is illustrated by the pointer 134. The content 604 comprising elements 138a-138c, as illustrated in FIG. 6B, is different from the content 602, comprising element 138d, as illustrated in FIG. 6A.

Referring again to FIG. 2, in an embodiment of the invention, prior to the step of receiving the indication of relevancy 126, the step of indicating the relevancy of the at least one element of the specified process step to the current process step is performed.

Referring again to FIG. 2, setting the indication of relevancy of a specified process step to a current process step 124 and/or setting the user context to a specified process step as function of the current step 123, may be performed manually and/or automatically. The indication of relevancy may be determined by a user of the system, a user that enters data, a system architect, an automated procedure and/or by any other means as appropriate to each specific case. The indication of relevancy may be noted, for example, by a string, tag, variable, rule, triggering event, and/or associated action.

The process described above may be, for example, a business process, workflow, learning process such as e-learning process, software wizard or any other process having more than one process step and an indication about the current process step.

The process step itself and/or the process step element may be implemented as one of the following examples: field, tab, window, note, text, image, widget, action, link, and a set of process step elements.

The contextual view provided to the user may be a device dependent view. US patent application No. 20050154741, entitled “Methods and computer systems for workflow management”, which is incorporated herein by reference, is an example of a method and system that provide the user a device dependent view by using self descriptive parts that identify what data is relevant to what device. In an embodiment of the invention, the step of providing the user with the contextual view is based on a self descriptive part that specifies details for generating the contextual view. In that case, the self descriptive part specifies details for generating a corresponding device independent representation for the contextual view.

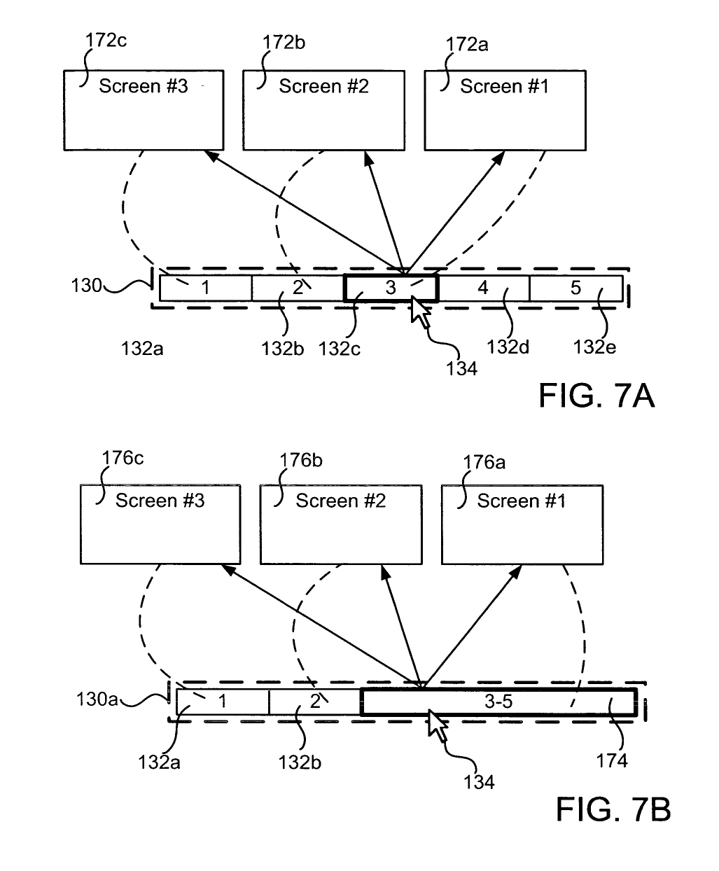

In an embodiment of another aspect of the invention, the following method is used for providing the user with a contextual view of a process comprising at least two process steps, wherein during execution, one of the process steps is a current step of the process. Referring to FIG. 7A, the process toolbar 130 illustrates process steps 132a-132e of an exemplary process. Process step #3 132c features screen #1 172a that is the process step view to be shown to a user of the process when step #3 132c is the current step and the user is viewing step #3 132c. In addition, process step #3 132c features a second view 172b and a third view 172c, wherein the second view 172b is associated with process step #2 132b and the third view 172c is associated with process step #1 132a. When the user is viewing process step #3 132c while process step #2 132b is the current process step, the user is supplied with the second view 172b. When the user is viewing process step #3 132c while process step #1 132a is the current process step, the user is supplied with the third view 172c.

There may be a plurality of process step views. For example, step 132b may include a process step view of its own and provide the user with other process step views when steps other that 132b are the current step of the process.

The process step comprising the process step view may comprise at least two process step views associated with the same current step of the process. In this case, the method may receive an indication of the user context, and based on the received indication of the user context, select the process step view to be provided to the user.

The user context may be selected from a large variety of context types. A detailed discussion about exemplary possible contexts disclosed below.

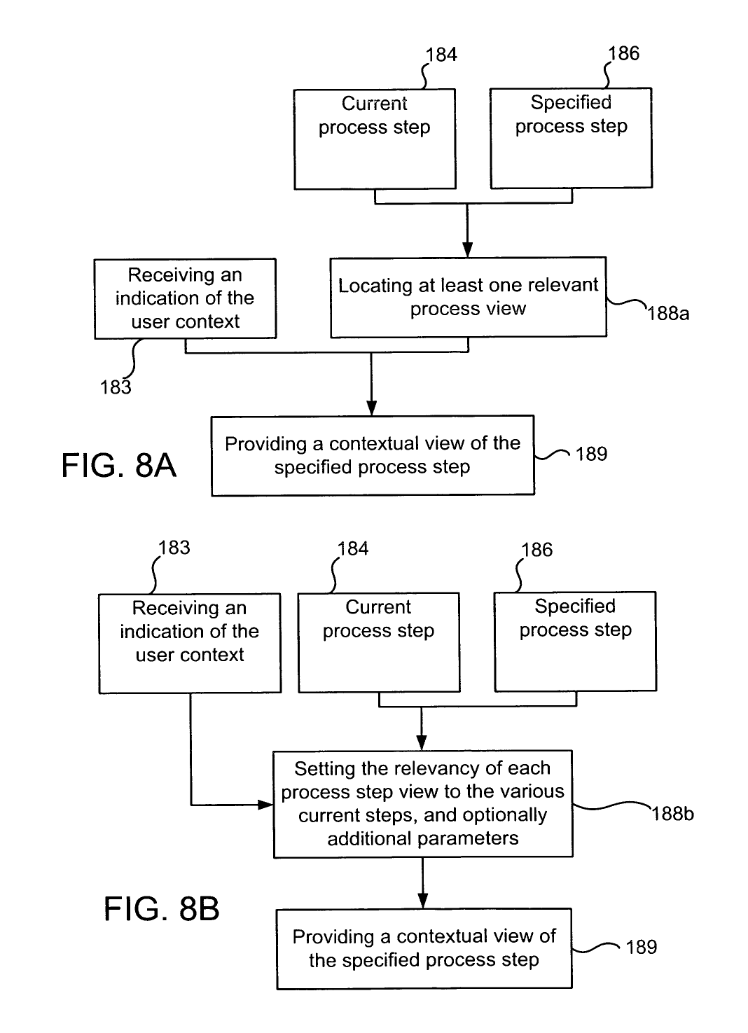

This option enables the system to further adapt the provided content to the context. Referring to an example illustrated by FIG. 8A, the current process step 184 and the specified process step 186 enable the system to locate at least one relevant process view at step 188a. By using the optional indication of the user context 183, the algorithm 189 is able to select the at least one contextual view of the specified process step in relation to the current process step. In that optional case, the contextual view of the specified process step provided to the user includes elements that are relevant to the current process step and to the user's context. It is to be understood that the order of the steps is usually not material to the method. For example, the step of locating the at least one relevant process view 188a may be canceled and/or integrated with the step of receiving an indication of the user context 183.

FIG. 8B illustrates a flow chart in accordance with another embodiment. The current process step 184, a specified process step 186, and optionally an indication of the user context 183 are provided to an algorithm 188b that sets the relevancy of each process step view to the various current steps, and optionally additional parameters. For example, indication of the user context may be used for supplying different views to different roles viewing the same process step.

In an embodiment of the invention, prior to the step of providing the user with a process step view, a step of setting the relevant process step view to each current step of the process is executed. Setting the relevancy of each process step view to the various current steps, and, optionally, to additional parameters, is illustrated by component 188b in FIG. 8B. The setting of relevancy 188b may be performed manually and/or automatically. The indication of relevancy may be noted for example by a string, tag, variable, rule, triggering event, and/or associated action.

Optionally, at least one of the process steps may have an abstract view of at least two process steps. FIG. 7B illustrates an embodiment of the invention wherein the process toolbar 130a comprises abstract steps. FIG. 7B, illustrates the case where the specified process step 174 is an abstraction-of process steps #3-#5 132c-e of FIG. 7A. When the specified step is abstracted process step 174 and the current process step is step 132a, screen #3 176c is supplied to the user; when the specified step is abstracted process step 174 and the current process step is step 132b, screen #2 176b is supplied to the user; and when the specified step is abstracted process step 174 and the current process step is abstracted process step 174, screen #1 176a is supplied to the user. In the same manner, when step #3 132c of FIG. 7A becomes the current step of the process, the view of process steps #1 132a and #2 132b may be changed to an abstracted view. Optionally, the fact that the specified process step 174 is an abstraction may not influence the associated screens.

The process may be for example a business process, worlflow, e-learning process, software wizard or any other process having more than one process step and an indication about the current process step.

The process step itself and/or the process step view element may be implemented as one of the following examples: field, tab, window, note, text, image, widget, action, link, and a set of process step elements.

The process step view provided to the user may be a device dependent process step view. The device dependent process step view may be implemented by utilizing descriptive parts that identify which data is relevant to which device. The self descriptive part specifies details for generating the contextual view.

It is to be understood that although FIG. 3A to FIG. 7B are illustrated using a process toolbar, which is referred to as 130, 130a, 160, or 160a, there is no intent to limit the present invention to the use of a process toolbar, and any other type of indication of the available and/or relevant process steps may be used instead.

In an embodiment of another aspect of the invention, the following method is used for providing a user with the relevant content.

(a) Providing the user with a toolbar, the toolbar comprising at least two navigable elements representing process steps. It is to be understood that any type of process steps indication may be used instead of the process toolbar. The process toolbar is referred to in the figures by reference numbers 130, 130a, 160, and 160a.

(b) Receiving a user's choice of one of the navigable elements.

(c) Providing the user with content about a process step represented by the navigable element, wherein the provided content is adapted to the user based on a current step of the process.

Optionally, the toolbar is a visual representation of the process. The visual representation may be a graph, flowchart, snapshot, process flow, etc. Optionally, the process is a business process, workflow, an e-learning process and/or a software wizard. Optionally, the provided content is further adapted according to the context of the user. Optionally, the content provided to the user comprises at least two versions, and adaptation of the provided content to the user comprises choosing one version from the at least two versions.

Above described embodiments supply the user with a contextual view of a process step. The following list includes types of contexts, examples of contexts and methods for deriving contexts. The list, or its equivalents, may be used in the embodiments of the present invention.

a) The context may be relevant Business Data, such as, user role, user's current and past projects, other projects of the user's company, user profile, other people in the user's role/project/department, user's company and company profile, user level of experience (for example novice, intermediate, expert) with the system, user's level of expertise related to the client selected by the user, meta-data associated with the user, and sources outside the user's environment such as user's profile on the web.

b) The context may be a physical status of the user, such as, for example, whether the user is hard of hearing, near-sighted or far-sighted. The system may take into account the user's temporary physical or mental status, for example, whether the user is distracted, nervous or tired. The user's temporary physical or mental status may be inferred from a measure of pulse or respiration rate of the user, a skin conductivity of the user, visual and vocal expressions of the user, user speed of activity or frequency of interaction with the device.

c) The context may be the user's current task and the user's goal, which is either an ultimate goal or a sub-goal, and to which the user seeks information relevant to achieve that goal.

d) The context may be user privileges and authority information.

e) The context may be the amount and type of resources available for the task at hand (for example, the current project's budget).

f) The context may be data from the user's device and application environment, such as, active programs in the user's environment, any menus, tabs or other controls selected by the user, documents in the user's environment, user's mailbox, schedule, preferences, available hardware and/or device, active documents and web-pages, and deriving the context from analyzing the text the user is working on.

g) Contexts may include a variety of types of information about devices within the computing system, such as device types, named users of the devices, device location, device capabilities, interaction methods, software platforms, the amount of free storage on a device, information about devices, data, and applications to which a particular device has access, information about connection bandwidth available to a device, information about network type, the latency to transfer data over a transmission medium and availability of differing network technologies, and information on whether a user has a device.

h) The context may be data about the user's physical environment, such as location, time and environmental conditions, such as temperature, speed, loudness, background noise, lightness or darkness, the weather, or nearby equipment. Such data may be measured by appropriate sensors or otherwise inferred.

i) The context may be the existence and/or identity of nearby users, for example, whether the user is alone or with someone else.

j) The context may be inferred from metadata, such as, user company's connections with other companies and financial data, information about other users that are associated with the user, and data about people related to the user. For example, the system may use information about the groups the user is a member of and about other members of such groups. Such information may be derived, for example, from a user's contact list or from distribution lists of which the user is a member.

k) The context may be history and logs, such as, history of user activity, history of user interaction with the system, and history of activity of the system receiving the data. For example, the system may provide information based on the user's most recent accesses to the system or the user's most frequent types of interaction with the system.

The following are examples of context derivation methods from various sources, such as user input, user profile, organizational databases, sensors, status of applications and devices in use:

a) The context may be based upon the user identity or function, wherein predefined contexts are stored for each user or class of user. The user identity may either be defined explicitly by using a user identifier such as log on ID for each user of the system, or implicitly by having a stored set of context definitions for each terminal able to access the system and assuming that the user for each terminal is always the same user or class of user.

b) A context definition may be based on the information requested by the user or the information sent for display in response to a request. Further, where the context definition is based on the information requested, the context definition may be based on either or both of the type of information requested and/or the actual value of the information requested.

c) The context of the application may be deduced from other available information including other user inputs to the application, dialogue between a user desktop and the application, or, where the application is run on a remote server, dialogue between a user terminal and the application, or dialogue between a web browser client and the application server or web server. The context of the application can of course be deduced based on more than one source of available information.

Although the present invention has been described in considerable detail with reference to certain embodiments thereof, other embodiments are possible. Therefore, the spirit and scope of the appended claims should not be limited to the description of the embodiments contained herein.

It is appreciated that certain features of the embodiments, which are, for clarity, described in the context of separate embodiments, may also be provided in various combinations in a single embodiment. Conversely, various features of the embodiments, which are, for brevity, described in the context of a single embodiment, may also be provided separately or in any suitable sub-combination.

It is to be understood that the embodiments are not limited in their applications to the details of the order or sequence of steps of operation or implementation of the methods set in the description, drawings, or examples.

Any citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

Any element in a claim that does not explicitly state “means for” performing a specific function, or “step for” performing a specific function, is not to be interpreted as a “means” or “step” clause as specified in 35 U.S.C. § 112, ¶ 6.

What is claimed is:

1. A computer-implemented method for providing a contextual view of a specified process step, comprising:
receiving an indication of relevancy of at least one element of the specified process step to a current process step, wherein the current process step is not the specified process step, and
providing a user with the contextual view of the specified process step,
wherein the contextual view of the specified process step comprises at least one relevant element based on the received indication of relevancy.

2. The method of claim 1, wherein the indication of relevancy is implemented by using a method selected from the group of: determining a set of rules that are operated on the process step, implementing the elements of the process step as business objects associated with operations, storing the indication of relevancy in a web service, indicating the relevancy by using content fragments, or storing the indication of relevancy in a tag.

3. The method of claim 1, wherein the indication of relevancy is implemented by using tags which are built hierarchically.

4. The method of claim 1, wherein the relevant elements provided to the user comprise an element without an indication of relevancy.

5. The method of claim 1, wherein the relevant elements provided to the user do not comprise an element without an indication of relevancy.

6. The method of claim 1, further comprising receiving an indication of the user context, and further basing the step of providing the user with the contextual view of the specified process step on the received indication of the user context.

7. The method of claim 1, wherein the received indication of relevancy of at least one element of the specified process step is an indication of relevancy to an element within the current process step.

8. The method of claim 1, further comprising the step of receiving an indication of the current process step and an indication of the specified process step, wherein the current process step is set by a user.

9. The method of claim 1, wherein the specified process step is an abstract view of at least two process steps.

10. The method of claim 1, further comprising, prior to the step of receiving the indication of relevancy, the step of setting the indication of relevancy of the at least one element of the specified process step to the current process step.

11. The method of claim 1, wherein the specified process step is a part of a process selected form the group of business process, workflow, e-learning process, software wizard, and a combination thereof.

12. The method of claim 1, wherein the step of providing the user with the contextual view is based on a self-descriptive part that specifies details for generating the contextual view.

13. The method of claim 12, wherein the self-descriptive part specifies details for generating a corresponding device independent representation for the contextual view.

14. A method for providing a process step view in a process comprising at least two process steps, referred to as a first process step and a second process step, wherein the first process step comprises at least two process step views, referred to as a first process step view and a second process step view, the method comprising:
providing a user with the first process step view when the first process step is the current step of the process; and providing the user with the second process step view when the second process step is the current step of the process.

15. The method of claim 14, wherein the second process step comprises at least two process step views, referred to as a third process step view and a fourth process step view, and further comprising:
providing the user with the third process step view when the second process step is the current step of the process; and providing the user with the fourth process step view when the first process step is the current step of the process.

16. The method of claim 14, wherein the first process step comprises at least two process step views associated with the same current step of the process, and further comprising:
receiving an indication of the user context; and selecting the process step view to be provided to the user based on the received indication of the user context.

17. The method of claim 14, wherein at least one of the first process step and the second process step comprises an abstract view of at least two process steps.

18. The method of claim 14, further comprising, prior to providing the user with the first or the second process step view, the step of setting the relevant process step view to each current step of the process.

19. The method of claim 14, wherein the process is selected form the group of business process, workflow, e-learning process, software wizard, and a combination thereof.

20. The method of claim 14, wherein providing the user with the process step view is based on a self-descriptive part that specifies details for generating the process step view.

21. A computer-implemented method comprising the steps of:
providing a user with a toolbar, the toolbar comprising at least two navigable elements representing process steps;
receiving a user's choice of one of the navigable elements; and
providing the user with content about a process step represented by the navigable element,
wherein the provided content is adapted to the user based on a current step of the process.

22. The method of claim 21, wherein the toolbar is a visual representation of the process.

23. The method of claim 21, wherein the provided content is further adapted according to the context of the user.

24. The method of claim 21, wherein the provided content comprises at least two views; and adaptation of the provided content to the user comprises choosing a view from the at least two views.
